(19) United States
(12) Patent Application Publication
(10) Pub. No.: US 2007/0131464 A1
(43) Pub. Date: Jun. 14, 2007

(54) Automatic transmission of hybrid vehicle

(76) Inventors: Kyung Won Hwang, Euijeongbu-city (KR); Wan Soo Kim, Hwaseong-city (KR); Kyung Ha Kim, Yongin-city (KR); Tal Chol Kim, Bucheon-city (KR); Yeon Ho Kim, Suwon-city (KR); Seong Jae Song, Seoul (KR); Joo Woong Youn, Seoul (KR); Hee Ra Lee, Anyang-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/305,720

(22) Filed: Dec. 15, 2005

(30) Foreign Application Priority Data
Dec. 14, 2005 (KR) 10-2005-0123099

(51) Int. Cl. B60K 6/00

(52) U.S. Cl. 180/65.2

(57) ABSTRACT

An exemplary automatic transmission of a hybrid vehicle according to an embodiment of the present invention includes a flywheel connected to an engine, a generator having a stator part and a rotor part, an input shaft connected with the rotor part, a hub coupled to an end of the input shaft, and a torsional damper connecting the flywheel with the hub, wherein the torsional damper includes a torsional spring and a plate, an end of the stator part is projected further toward the engine than an end of the rotor part and forms a projected portion, a vacant space is formed inside the projected portion, the plate is formed to be bent such that a mounting part mounted to the torsional spring is nearer to the generator than a mounting part mounted to the flywheel, and at least a part of the torsional spring is disposed in the vacant part.

### CROSS-REFERENCE TO RELATED APPLICATION

This application claims priority to and the benefit of Korean Patent Application No. 10-2005-0123099 filed in the Korean Intellectual Property Office on Dec. 14, 2005, the entire contents of which are incorporated herein by reference.

### BACKGROUND OF THE INVENTION

(a) Field of the Invention

The present invention relates to an automatic transmission of a hybrid vehicle for reducing a length of the transmission by bending a part of a torsional damper such that at least a part of the torsional damper is disposed in a vacant space formed inside of a projected portion of a stator part of the generator.

(b) Description of the Related Art

In a general hybrid vehicle, an engine and a drive motor for generating power for driving and a generator for generating electrical energy for charging a battery are provided.

A driving torque generated by the engine is delivered to an input shaft of a transmission through a flywheel. Here, the flywheel and the input shaft are connected by a torsional damper and a hub of the input shaft.

Therefore, the flywheel is disposed at one side (near the engine) of the torsional damper, and the generator is disposed at an opposite side to the flywheel.

To dispose the torsional damper between the flywheel and the generator, space should be allocated. Therefore, it is very difficult to shorten the longitudinal length of the transmission along the input shaft due to the space for disposing the torsional damper.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an automatic transmission of a hybrid vehicle having advantages of shortening a length of the transmission by bending a part of a torsional damper, and disposing at least a part of the torsional damper at a vacant space formed inside of a projected portion of a stator part of the generator.

An exemplary automatic transmission of a hybrid vehicle according to an embodiment of the present invention includes a flywheel connected to an engine, a generator having a stator part and a rotor part installed inside of the stator part, an input shaft connected with the rotor part of the generator, a hub coupled to an end of the input shaft, and a torsional damper connecting the flywheel with the hub, wherein, the torsional damper includes a torsional spring mounted to the hub and a plate mounted to the torsional spring and the flywheel, an end of the stator part is projected further toward the engine than an end of the rotor part and forms a projected portion, a vacant space is formed inside the projected portion, the plate is formed to be bent such that a mounting part mounted to the torsional spring is nearer to the generator than a mounting part mounted to the flywheel, and at least a part of the torsional spring is disposed in the vacant space.

The plate may include a first perpendicular part that is perpendicular to the input shaft and is mounted to the flywheel, a second perpendicular part which is perpendicular to the input shaft and is mounted to the torsional spring, and a slope part connecting the first perpendicular part with the second perpendicular part, wherein the first perpendicular part is nearer to the engine than the second perpendicular part.

The automatic transmission of a hybrid vehicle may further include a first delivery shaft parallel with the input shaft, and a second delivery shaft parallel with the first delivery shaft and directly connected with a differential gear, wherein a rotational torque of the input shaft may be delivered to the differential gear through the first delivery shaft and the second delivery shaft.

### BRIEF DESCRIPTION OF THE DRAWINGS

FIG. 1 is a cross-sectional view of an automatic transmission of a hybrid vehicle according to an exemplary embodiment of the present invention.

Description of Reference Numerals Indicating Primary Elements in the Drawings

| | | |
|---|---|---|
| 10: | planetary gear set | 20: differential gear |
| 10: | [symbol] | 20: [symbol] |
| 100: | generator | 110: stator part (stator) |
| 110a: | projected portion | |
| 120: | rotor part | 200: torsional damper |
| 210: | plate | 211: first perpendicular portion |
| 212: | slope portion | 213: second perpendicular portion |
| 220: | torsional spring | 300: hub |
| 400: | input shaft | 500: engine |
| 600: | empty space | 700: flywheel |
| 800: | drive motor | 910: first mounting part |
| 920: | second mounting part | |

### DETAILED DESCRIPTION OF THE EXEMPLARY EMBODIMENT

An exemplary embodiment of the present invention will hereinafter be described in detail with reference to the accompanying drawings.

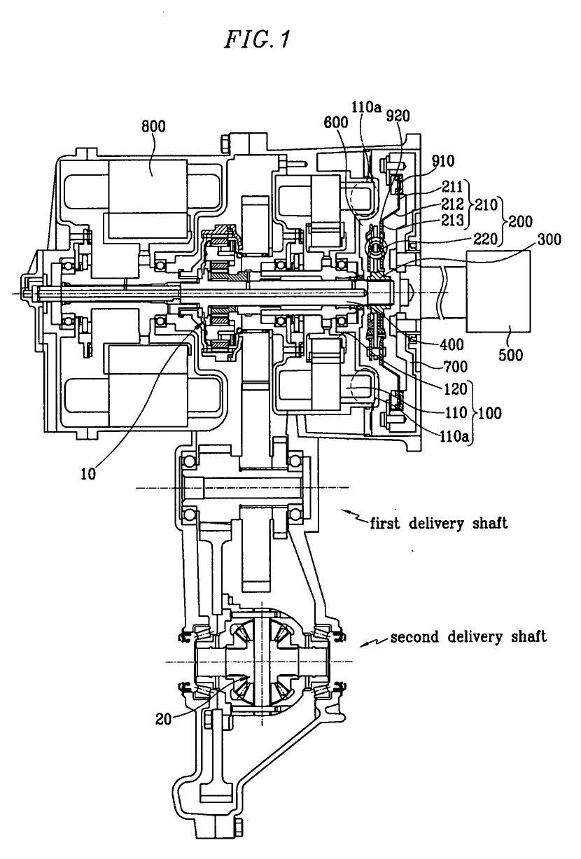

FIG. 1 is a cross-sectional view of an automatic transmission of a hybrid vehicle according to an exemplary embodiment of the present invention.

Referring to FIG. 1, an engine 500 and a drive motor 800 for generating power for driving and a generator 100 for generating electrical energy for charging a battery are provided in a hybrid vehicle according to the exemplary embodiment of the present invention.

The engine 500 is connected to a flywheel 700 so as to deliver power, and the flywheel 700 is connected to a hub 300 of an input shaft 400 through a torsional damper 200.

The input shaft 400 is connected with a first delivery shaft through a planetary gear set 10, and the first delivery shaft is connected with a second delivery shaft through gears fixedly coupled to the respective shafts.

A differential gear 20 is fixedly coupled to the second delivery shaft.

Therefore, when the vehicle runs, a driving torque generated by the engine 500 is delivered to the input shaft 400 through the flywheel 700, and a driving torque of the input shaft 400 is delivered to the differential gear 20 through the torsional damper 200 and the hub 300.

The input shaft 400 is connected with the generator 100. Therefore, when generating, a driving torque generated by the engine 500 is delivered to the input shaft 400 of an automatic transmission through the flywheel 700, the torsional damper 200, and the hub 300 of the input shaft 400, and then, a driving torque of the input shaft 400 operates the generator 100.

The generator 100 includes a stator part 110 and a rotor part 120 provided inside of the stator part 110. Here, an end-of the stator part 110 is projected further toward the flywheel 700 than an end of the rotor part 120.Reference numeral 110a indicates a projected portion 110a which is the projected portion of the stator part 110.

Therefore, near the center of the projected portion 110a of the stator part 110 and an outer part of the rotor part 120, a vacant space 120 is allocated. The stator part 110 contains a stator coil.

The torsional damper 200 connects a flywheel 700 with a hub 300 of the input shaft 400 of the transmission. Therefore, the flywheel 700 is disposed at one side of the torsional damper 200 toward the engine 500, and the generator 100 is disposed at the opposite side of the torsional damper 200.

The torsional damper 200 includes a plate 210 mounted to the flywheel 700, and a torsional spring 220 disposed between the plate 210 and the hub 300.

The plate 210 includes a first perpendicular part 211 that is perpendicularly disposed to the input shaft 400 and is mounted to the flywheel 700, a second perpendicular part 213 that is perpendicularly disposed to the input shaft 400 and is mounted to the torsional spring 220, and a slope part 212 connecting the first perpendicular part 211 with the second perpendicular part 213. Therefore, the plate 210 has a double-bent shape with the first perpendicular part 211 near the engine 500 and the second perpendicular part 213 near the generator 100.

Hereinafter, a mounting part of the plate 210 and the flywheel 700 is called as a first mounting part 910, and a mounting part of the plate 210 and the torsional spring 220 is called as a second mounting part 920. The first mounting part 910 is relatively nearer to the engine 700 than the second mounting part 920, and the second mounting part 920 is relatively nearer to the generator 100 than the first mounting part 910. Here, since mounting structures of the first mounting part 910 and the second mounting part 920 are obvious for a person of an ordinary skill in the art, a detailed description of the mounting structure will be omitted.

The torsional spring 220 is provided to be disposed at the empty space 600 formed inside of the projected portion 110a of the stator part 110 of the generator 100. A portion of the stator part 110 is projected further toward the engine 500 than the rotor part 120 and forms a projected portion 110a. Therefore, the empty space 600 is formed at the central part of the projected portion 110a, and the torsional spring 220 is disposed at the empty space 600. Therefore, the length of the transmission can be shortened.

According to the present invention, since the plate of the torsional damper has a double-bent shape and the torsional spring is disposed at the vacant space formed inside of the projected portion of the stator part of the generator, a length of the transmission can be shortened.

While this invention has been described in connection with what is presently considered to be a practical exemplary embodiment, it is to be understood that the invention is not limited to the disclosed embodiment, but, on the contrary, is intended to cover various modifications and equivalent arrangements included within the spirit and scope of the appended claims.

What is claimed is:

1. An automatic transmission of a hybrid vehicle, comprising:
a flywheel connected to an engine;
a generator having a stator part and a rotor part installed inside of the stator part;
an input shaft connected with the rotor part of the generator;
a hub coupled to an end of the input shaft; and
a torsional damper connecting the flywheel with the hub, wherein
the torsional damper comprises:
a torsional spring mounted to the hub; and
a plate mounted to the torsional spring and the flywheel,
an end of the stator part is projected further toward the engine than an end of the rotor part and forms a projected portion,
a vacant space is formed inside the projected portion,
the plate is formed to be bent such that a mounting part mounted to the torsional spring is nearer to the generator than a mounting part mounted to the flywheel, and
at least a part of the torsional spring is disposed in the vacant part.

2. The automatic transmission of a hybrid vehicle of claim 1, wherein
the plate comprises:
a first perpendicular part that is perpendicular to the input shaft and is mounted to the flywheel;
a second perpendicular part that is perpendicular to the input shaft and is mounted to the torsional spring; and
a slope part connecting the first perpendicular part with the second perpendicular part, wherein
the first perpendicular part is nearer to the engine than the second perpendicular part.

3. The automatic transmission of a hybrid vehicle of claim 2, further comprising:
a first delivery shaft parallel with the input shaft; and
a second delivery shaft parallel with the first delivery shaft and directly connected with a differential gear, wherein
a rotational torque of the input shaft is delivered to the differential gear through the first delivery shaft and the second delivery shaft.
